(19) United States
(12) Patent Application Publication
(10) Pub. No.: US 2025/0291904 A1
(43) Pub. Date: Sep. 18, 2025

(54) SYSTEMS AND METHODS FOR INTEGRATIVE ANALYSIS OF MULTIMODAL COMMUNICATION FEATURES FOR MISAPPROPRIATION DETECTION

(71) Applicant: BANK OF AMERICA CORPORATION, Charlotte, NC (US)

(72) Inventors: Joseph Benjamin Castinado, North Glenn, CO (US); Shailesh Lolam, Glendale, AZ (US); Hope Barus, Indian Land, SC (US)

(73) Assignee: BANK OF AMERICA CORPORATION, Charlotte, NC (US)

(21) Appl. No.: 18/604,039

(22) Filed: Mar. 13, 2024

(51) Int. Cl. G06F 21/55; G06N 20/00

(52) U.S. Cl. CPC G06F 21/554; G06F 2221/034; G06N 20/00

(57) ABSTRACT

Systems, computer program products, and methods are described herein for integrative analysis of multimodal communication features for misappropriation detection. The present invention is configured to acquire data across multiple communication modalities including spoken communication, written text, and non-verbal cues. The invention standardizes and preprocesses this diverse data, extracting key features indicative of communication patterns. Utilizing a sophisticated machine learning model, the system analyzes these patterns to identify deviations from established norms, potentially signaling attempts at misappropriation.

### TECHNOLOGICAL FIELD

Example embodiments of the present disclosure relate to integrative analysis of multimodal communication features for misappropriation detection.

### BACKGROUND

In the digital era, electronic communications, including video chats, texts, and phone calls, have become ubiquitous. However, this surge in online interactions has also led to an increase in attempts to access or misappropriate sensitive data and software packages. Traditional methods for detecting such practices often fall short, especially in environments where communications lack physical cues and must be evaluated at face-value. The complexities involved in analyzing multimodal communication features such as vocal nuances, typing patterns, and facial expressions in real-time present significant challenges. Furthermore, the absence of reliable mechanisms to correlate these diverse data points and identify deviations from historical behavior patterns exacerbates the difficulty in detecting misappropriation attempts. Recognizing these challenges, the Applicant has identified a critical need for an advanced solution capable of analyzing these multimodal communication features to enhance the detection of misappropriation in electronic communications.

Applicant has identified a number of deficiencies and problems associated with integrative analysis of multimodal communication features for misappropriation detection. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for integrative analysis of multimodal communication features for misappropriation detection. This invention leverages a large language model (LLM) powered by artificial intelligence (AI) to analyze electronic communications across various modalities such as speech patterns, typing speed, and facial expressions to detect potential attempts at data or software misappropriation.

The core of the invention involves collecting and analyzing data from historical and real-time communications to identify deviations from established behavior patterns. By integrating the analysis of various communication modalities and correlating these with physical characteristic verifications (e.g., fingerprint analysis, facial recognition, or the like), the system significantly enhances its ability to detect practices aimed at misappropriating data. This multifaceted approach not only improves the accuracy of misappropriation detection but also offers a novel method for verifying user identities, thereby addressing a significant gap in the current state of electronic communication security. Moreover, the system's ability to tailor its analysis to specific users, industries, or applications further underscores its versatility and effectiveness in combating data and software package misappropriation.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for integrative analysis of multimodal communication features for misappropriation detection, in accordance with an embodiment of the disclosure;

FIG. 2 illustrates an exemplary machine learning (ML) subsystem architecture 200, in accordance with an embodiment of the invention; and

FIG. 3 illustrates a process flow for integrative analysis of multimodal communication features for misappropriation detection, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “artificial intelligence” (AI) refers to a branch of computer science dedicated to creating systems capable of performing tasks that typically require human intelligence. These tasks include, but are not limited to, understanding natural language, recognizing patterns, learning from data, making decisions, and solving problems. AI systems may utilize various methodologies, including machine learning, deep learning, rule-based systems, and cognitive computing, to process data and execute tasks autonomously or with minimal human intervention.

As used herein, a “large language model” (LLM) refers to a type of artificial intelligence system designed to understand, generate, and manipulate human language. LLMs are trained on vast datasets of text to learn language patterns, structures, and nuances. These models can perform a wide range of language-related tasks, such as text generation, translation, summarization, and sentiment analysis. LLMs operate by predicting the likelihood of a sequence of words or generating new text based on a given context.

As used herein, “multimodal data analysis” refers to the process of analyzing and integrating information from multiple sources or types of data, such as text, audio, video, and biometric data. This approach enables a more comprehensive understanding of content or behavior by leveraging the strengths of each data type. In the context of this invention, multimodal data analysis involves correlating features from different communication modalities, such as voice, facial expressions, and typing patterns, to detect deceptive behaviors.

As used herein, “behavioral deviation analysis” refers to the method of comparing current user behaviors with historical behaviors to identify anomalies or deviations. This analysis is crucial for detecting potential malfeasant or deceptive activities, as significant deviations from established patterns may indicate an attempt to misappropriate data or engage in unauthorized access.

As used herein, “communication modalities” refer to the various forms and methods through which users can engage in electronic communications. This includes, but is not limited to, text messaging, video chatting, voice calls, and email. Each modality presents unique characteristics and data types, such as speech patterns in voice calls or typing speed in text messaging, that can be analyzed to assess the authenticity and intent of the communication.

As used herein, “user verification mechanisms” refer to the systems and methods employed to confirm the identity of a user. These mechanisms may include, but are not limited to, traditional authentication methods such as passwords and PINs, as well as biometric verification techniques like fingerprint scanning, facial recognition, and iris scans. User verification mechanisms are integral to ensuring that electronic communications are secure and that access to data and software packages is appropriately controlled.

As used herein, “anomaly detection” refers to the process of identifying patterns in data that do not conform to expected behavior. It is a technique used in various fields such as cybersecurity, finance, and manufacturing to identify unusual patterns that may signify important, often critical, information. In the context of this invention, anomaly detection involves analyzing communication data to identify deviations from historical and expected user behaviors. This could include, but is not limited to, unusual speech patterns, typing rhythms, and interaction frequencies that differ significantly from a user's typical behavior. The primary goal of anomaly detection in this context is to flag potential security issues, such as attempts to access or misappropriate data and/or software packages, by detecting and analyzing irregularities that suggest deceptive or malicious activities.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

The technology introduced herein utilizes the capabilities of artificial intelligence (AI) and large language models (LLMs) to enhance security measures in electronic communications. By harnessing the power of AI, this system meticulously analyzes the nuances of multimodal communications, including voice, text, facial expressions, and typing patterns, to detect and prevent data misappropriation and ensure the integrity of digital interactions. The digital realm is fraught with challenges, particularly in safeguarding sensitive information during electronic communications. Traditional security measures often fail to detect subtle attempts at data misappropriation, as deceptive behaviors can be difficult to discern without the context provided by physical interactions. The lack of effective tools to analyze and correlate various communication modalities in real-time further complicates the detection of misappropriation activities, leaving individuals and organizations vulnerable to these issues.

As such, this disclosure presents a system that integrates the analysis of multimodal communication features to detect potential misappropriation. By employing artificial intelligence and large language models, the system scrutinizes the subtleties of user interactions across various platforms to identify anomalies that deviate from established behavior patterns. This innovative approach not only enhances the detection of malfeasant activities but also reinforces the security of electronic communications, ensuring that users can interact with confidence and trust.

What is more, the present disclosure provides a technical solution to a technical problem. As described herein, the technical problem includes the difficulty in accurately detecting deceptive behaviors in electronic communications aimed at data or software misappropriation. The technical solution presented herein allows for the real-time analysis of multimodal communication features (such as vocal nuances, typing rhythms, facial expressions, etc.) using artificial intelligence and large language models to identify deviations from historical behavior patterns that suggest malfeasant activity. In particular, this solution is an improvement over existing solutions to the problem of detecting deceptive behaviors by: (i) utilizing advanced AI algorithms to analyze data with fewer steps, thus reducing the amount of computing resources, such as processing resources, storage resources, network resources, and/or the like, that are being used; (ii) providing a more accurate solution to the problem, thus reducing the number of resources required to remedy any errors made due to a less accurate solution; (iii) automating the detection process and removing manual input and waste from the implementation of the solution, thus improving speed and efficiency of the process and conserving computing resources; (iv) intelligently determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

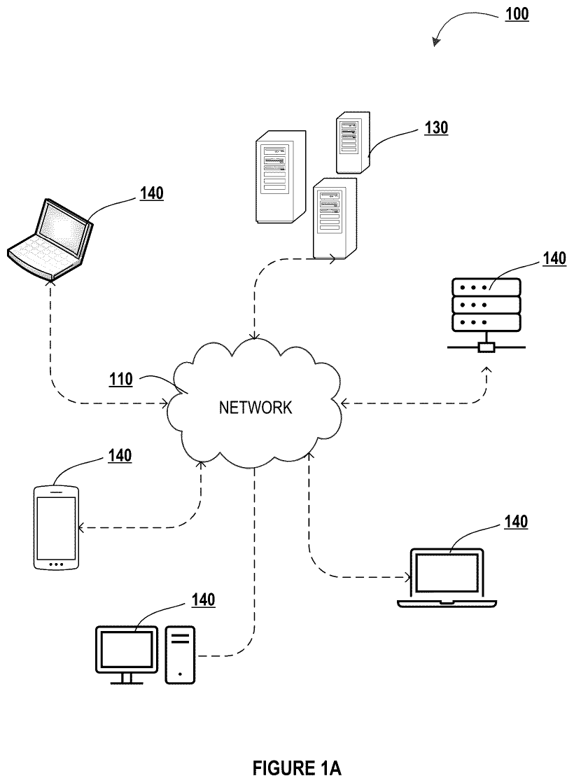

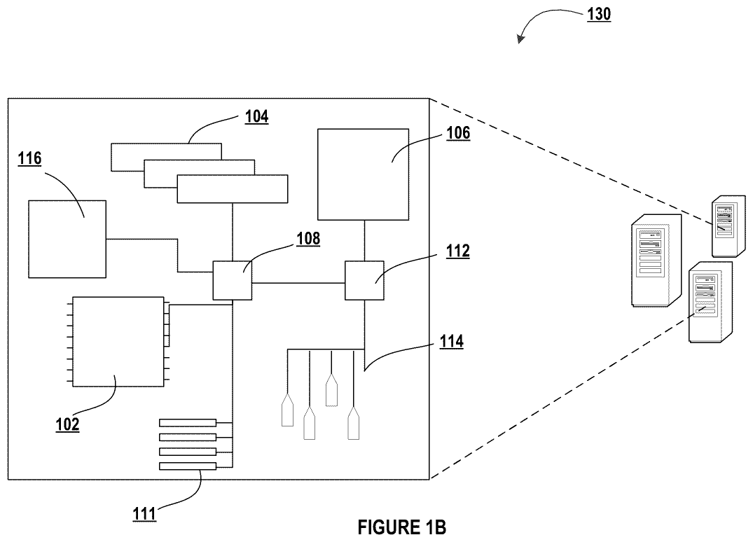

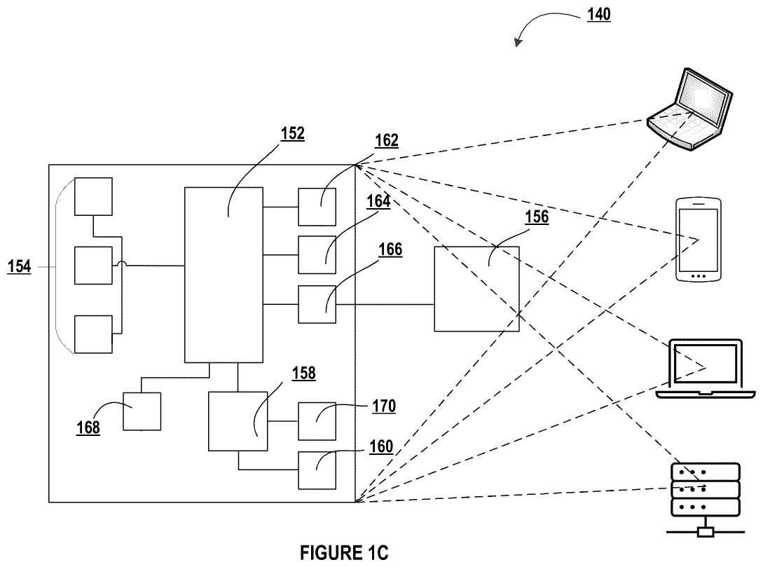

FIGS. 1A-1C illustrate technical components of an exemplary distributed computing environment 100 for integrative analysis of multimodal communication features for misappropriation detection, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

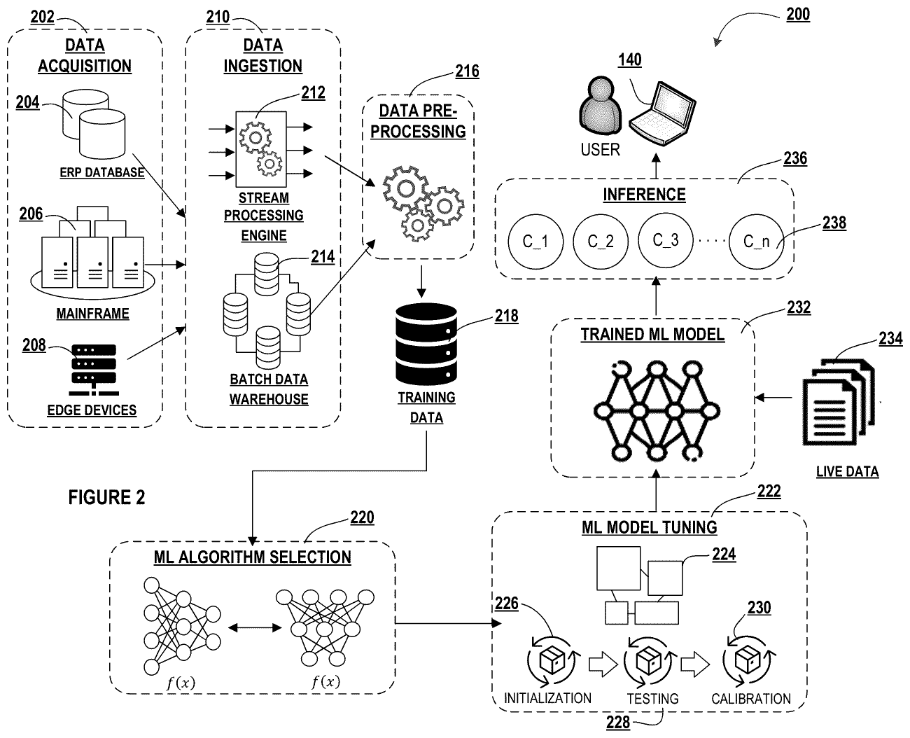

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In this context, the data acquisition is critical for enriching the machine learning model with diverse inputs, enhancing its capability to detect anomalies and misappropriation attempts in communications. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The robustness of this subsystem is pivotal for the invention's goal to efficiently identify deceptive behavior by analyzing complex patterns across multiple communication modalities. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. These processes are integral to refining the inputs for the machine learning model, enabling it to discern normal from anomalous communication behavior effectively. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. This training process is essential for the system's capability to discern between legitimate and deceptive communications, enabling the model to adapt to new, unseen communication patterns that may indicate misappropriation. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. These diverse algorithm types ensure the system's flexibility and effectiveness in handling a wide range of communication anomalies, from subtle indicators of deception to more overt attempts at data misappropriation. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. This iterative process is vital for enhancing the system's precision in identifying potential misappropriations through nuanced analysis of communication patterns. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

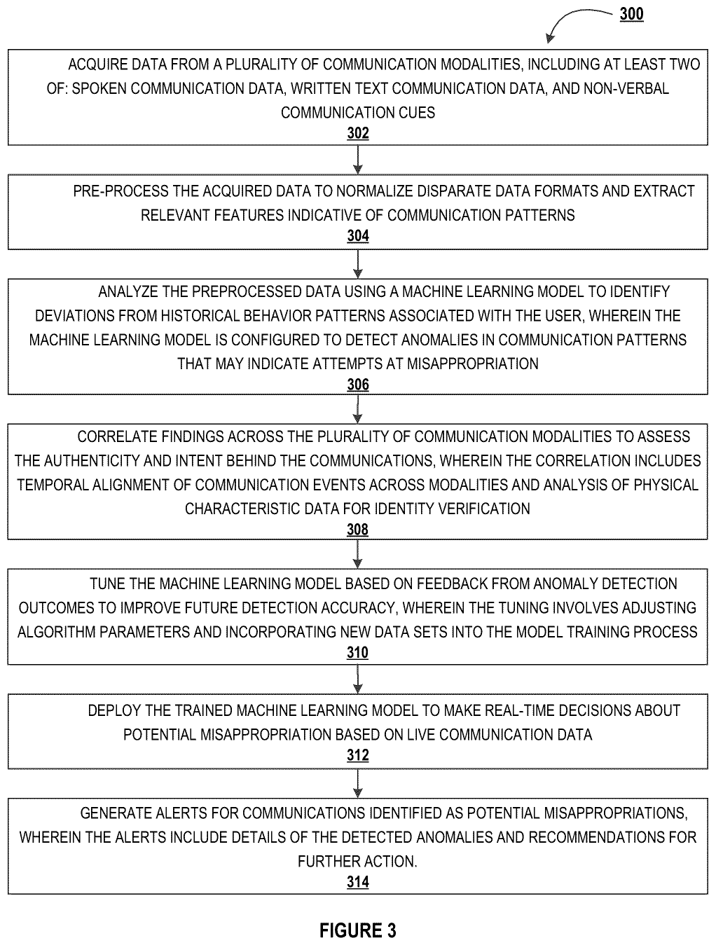

FIG. 3 illustrates a process flow for integrative analysis of multimodal communication features for misappropriation detection, in accordance with an embodiment of the disclosure. In step 302, the system begins by acquiring data from a plurality of communication modalities. This process involves collecting spoken communication data, written text communication data, and non-verbal communication cues. In an exemplary embodiment, the data acquisition engine may be implemented using high-throughput data pipelines, such as Apache Kafka, to handle the ingestion of large-scale, streaming data. From a coding perspective, this could involve utilizing APIs to interface with various communication platforms, like SIP for voice or SMTP for emails. The engine might be coded in a language suited for concurrent operations, such as Go or Java. On the hardware side, this may involve servers with multi-core processors and high-bandwidth network interfaces to support real-time data capture. The acquisition is carried out by the data acquisition engine, which taps into various data sources that may include, but are not limited to, audio recordings, text message logs, emails, and live video feeds. The audio and video data may be captured via digital signal processing (DSP) hardware to facilitate noise reduction and signal enhancement. This step is crucial as it establishes the foundational dataset from which potential misappropriations can be detected. The data acquisition engine ensures that the data collected encompasses a comprehensive set of indicators that are reflective of user behavior across different communication platforms.

In the pre-processing step 304, the system's data pre-processing engine takes the disparate data formats gathered from the initial acquisition and normalizes them to a consistent format. To achieve this from a coding perspective, the system might employ libraries such as Pandas in Python to transform and standardize data structures, while utilizing regular expressions to parse and clean text data. The pre-processing engine could utilize natural language processing (NLP) libraries like NLTK or SpaCy for text data and OpenCV for processing visual cues from video data. This engine extracts relevant features indicative of communication patterns, such as speech intonation, typing speed, and facial expressions. The hardware suited for this step may consist of GPUs to accelerate the processing of computationally intensive tasks such as image and speech recognition. The normalization process is essential for aligning the data temporally and contextually, making it suitable for analysis by the machine learning model. This step also includes cleansing the data of any irrelevant or redundant information, ensuring that the subsequent analysis is based on high-quality and relevant data inputs. Moreover, in some embodiments, this step may be augmented with data validation frameworks to ensure integrity and data quality before it enters the machine learning pipeline.

Step 306 involves the core analytical function of the system, where the preprocessed data is analyzed by a machine learning model. The model is designed to identify deviations from historical behavior patterns associated with the user, focusing on anomalies that may suggest misappropriation. In an exemplary embodiment, the analysis might be executed through machine learning frameworks like TensorFlow or PyTorch, where, as appreciated by one of ordinary skill in the art, complex neural networks can be trained to detect subtle irregularities. Implementation of this embodiment may include writing custom code for feature extraction, anomaly detection, and possibly using reinforcement learning techniques that can evolve with the data. In terms of supporting hardware for the embodiment, high-performance computing clusters with specialized hardware accelerators, such as Tensor Processing Units (TPUs) or Graphical Processing Units (GPUs), may be employed to facilitate the intensive computational demands of machine learning workloads. It is understood that the invention uses a variety of algorithmic techniques to evaluate communication behaviors and their alignment with established norms. When the model identifies significant deviations, it may flag these instances for further investigation, utilizing the rich, multidimensional data set created by the aforementioned steps.

In step 308, the system correlates findings across the multiple communication modalities. This step assesses the authenticity and intent behind the communications by examining the temporal alignment of events and analyzing physical characteristic data for identity verification. In some embodiments, this correlation may be facilitated by advanced algorithms capable of synchronizing and integrating multimodal data streams; this might involve complex event processing (CEP) systems or customized software that can handle asynchronous data feeds. As appreciated by one of ordinary skill in the art, to support such operations, hardware with high-speed RAM and multicore CPUs may be necessary to manage the simultaneous processing of varied data types and high-throughput I/O for real-time analytics. By doing so, the system builds a multi-faceted data log of user behavior that accounts for both the content and context of communications. This integrative approach ensures that assessments of authenticity are based on a holistic view of user interactions.

The machine learning model tuning, represented in step 310, is an iterative process where the system refines the model based on feedback from the anomaly detection outcomes, or anomaly detection feedback. In an exemplary embodiment, the tuning could be automated using machine learning operations (MLOps) practices, where continuous integration and delivery (CI/CD) pipelines are established for model training and deployment. Code-wise, it is understood that this may involve utilizing hyperparameter tuning libraries like Hyperopt or Optuna. In terms of hardware, scalable cloud infrastructure may be provisioned to dynamically adjust resources based on the computational needs of the tuning process. It is understood that the system adjusts algorithm parameters and incorporates new data sets into the model training process to improve future detection accuracy. Version control systems such as Git may be used to track iterations of the model and dataset changes, ensuring reproducibility and systematic enhancements over time. This self-improvement cycle ensures that the model stays current with evolving communication patterns and becomes more adept at detecting sophisticated attempts at misappropriation over time.

Upon successful training and tuning, as depicted in step 312, the system deploys the machine learning model to make real-time decisions about potential misappropriation based on live communication data. In some embodiments, this deployment may typically involve using containerization platforms and orchestration systems such as Kubernetes, which may allow for scalable and manageable application deployment. The actual deployment might be facilitated by model serving tools like TensorFlow Serving or TorchServe. This step involves integrating the model into the operational environment where it can assess ongoing communications, applying its trained capabilities to detect and flag potential issues as they occur. Specialized server hardware optimized for low-latency processing, possibly equipped with in-memory computing capabilities, may be ideal in exemplary embodiments for handling real-time data processing needs. This real-time analysis allows for prompt detection and response to identified security issues.

Finally, step 314 involves the generation of alerts for communications identified as potential misappropriations. The alerts articulate the details of the detected anomalies and provide recommendations for further action. It is understood that this may be implemented through a rules engine that interprets the model's findings and triggers alerts based on pre-defined criteria, encoded in a language like Python or Java. In some embodiments, the alerts may be integrated with messaging systems such as Slack, email, or SMS for immediate notification, using APIs for each respective service. This step serves as the output interface for the system, delivering actionable intelligence to the entity responsible for addressing the misappropriation attempts. It ensures that potential issues are communicated effectively, allowing for swift and informed decision-making.

In an exemplary embodiment of the system, an entity engaged in managing various transactional operations may employ the disclosed invention to monitor interactive customer service exchanges. The system meticulously observes and analyses a spectrum of communication modalities utilized during customer engagements, such as vocal intonation during telephonic conversations, cadence and rhythm of typing in chat support interfaces, and nuanced non-verbal cues displayed by representatives in video conferencing sessions. By scrutinizing these interactions, the system is calibrated to identify aberrant patterns that diverge from established baselines of behavior, which might suggest attempts at misappropriation.

Within this framework, the system is particularly sensitive to interactions that encompass discussions of high-value exchanges or alterations to payment channels. It is understood that, given the machine learning capabilities of the invention, the system is adept at pinpointing instances where the demeanor of a customer service representative exhibits atypical characteristics, such as a shift in the typical dialogue pace, or a discernible hesitancy in responding to standard transactional queries. The rigorous examination extends to scrutinizing subtleties within non-verbal communications, using advanced machine learning models trained to correlate eye movement, facial expressions, and gestures against a repository of standard communicative behaviors.

Further, in this embodiment, the system utilizes real-time data acquisition to construct a comprehensive and dynamic data log for each representative, against which ongoing communications are continually referenced. Should a representative's behavioral metrics, as recorded during high-volume or amount transactions, stray from their historical data log pattern, the system is engineered to flag such incidents for immediate review. The flagging mechanism is underpinned by a complex analytical engine that assesses the probabilistic weight of each deviation, factoring in the contextual gravity of the exchange and the accumulated historical data of similar transactional interactions.

In some embodiments, the flagging mechanism operates through an intricate analytical engine that utilizes a Bayesian inference model to calculate the probabilistic weight of behavioral deviations. For each observed interaction, the system computes a posterior probability that combines prior knowledge of the representative's behavioral history with the likelihood of observed behavior during current interactions. The algorithm may calculate the likelihood ratio, comparing the probability of observing such behavior if it were associated with typical operations versus the probability of such behavior being related to misappropriation.

For instance, if a representative typically takes an average of 5 seconds to respond to queries regarding high-value transactions but suddenly starts taking 15 seconds, the system calculates the deviation from the mean response time. Based on historical data, the system may know that 95% of the time, the response time is within 2 seconds of the mean. If the observed behavior is within the 5% tail, the system increases the probability scale related to a potential issue. This could be a scale where a probability under 5% may indicate business as usual, 5-10% might require closer monitoring, and over 10% could trigger an alert for potential misappropriation.

Given the machine learning engine underpinning the system, the engine is able to employ a dynamic thresholding method where these probability thresholds are not static; they are adjusted in real-time based on the evolving data patterns and the gravity of the transaction, or the like. In some embodiments, the system may be tuned to consider contextual factors such as transaction amount, the timing of the transaction relative to typical business patterns, and the frequency of such deviations, or the like. If the calculated probability exceeds a predetermined threshold, an alert is generated. This alert could activate secondary protocols such as changing, adding, or increasing level or difficulty of authentication procedures, initiating a secondary review of the transaction, or flagging the event for compliance review by a human user.

This probabilistic determination is computed using real-time statistical analysis, factoring in the standard deviation, variance, and mean of the representative's historical communication patterns. The calculations can be conducted using a statistical analysis module coded in Python or R, utilizing real-time processing power from CPUs optimized for high-speed mathematical computations. The module constantly updates its parameters, refining its predictions with each new piece of data, thereby maintaining the sensitivity and specificity required to discern legitimate anomalies from benign outliers.

In conjunction with anomaly detection, the system also enacts preventative mechanisms that operate across the entity's communication platforms. For instance, during a detected event of concern, it can subtly introduce additional verification steps in the transaction process, or initiate an auxiliary review by a secondary oversight team. These measures are implemented seamlessly within the flow of communication, thereby reinforcing the integrity of the entity's operational channels without impeding the user experience. Overall, the system serves as an integral component of the entity's comprehensive strategy to safeguard its operational integrity and maintain the security of its clients' resources.

In an additional exemplary embodiment tailored for corporate entities tasked with safeguarding sensitive intellectual property (IP) during virtual meetings, the invention operates as a multi-layered mechanism. This embodiment engages a sophisticated analysis of communicative dynamics among participants, scrutinizing a rich array of behavioral data. In some embodiments, the system evaluates facial micro-expressions, modulations in voice frequency that could indicate stress levels, and lexical anomalies within the conversational context when sensitive IP-related topics are under discussion.

In this embodiment, data collection may be achieved via a multi-channel process that begins with the reception of video and audio streams from participants' devices during virtual meetings. In some embodiments, the system described herein interfaces with the video conferencing software's API to access the feed directly or may utilize peripheral cameras and microphones positioned to capture clear visuals and audio within the meeting environment. For enhanced depth and field of analysis, the room where a participant is located may also be equipped with dedicated video cameras that provide additional visual data streams, offering alternative angles and broader views which are particularly useful for capturing non-verbal cues in a group setting.

Once captured, these raw data streams are relayed to a central processing unit, which may be hosted on a secure cloud service or on-premise servers with high-throughput capabilities. The system segments the incoming data by individual participants, employing edge computing techniques for initial preprocessing to reduce latency. These techniques include real-time frame analysis for facial recognition, pitch analysis modules for detecting voice modulations, and text stream processors that apply NLP algorithms to transcribed audio data. Each modality's data stream is timestamped and synchronized to preserve the relational context of the conversation flow, forming a composite and temporal map of the meeting's discourse dynamics.

In this embodiment, data acquisition may be meticulously orchestrated to capture high-fidelity information from a multitude of sources. It is understood that textual data may be gathered through chat logs and digital whiteboard interactions. Once captured, these multimodal data streams are formatted into standard file types such as MP4 for video, WAV or MP3 for audio, and plain text for written communication. As such, these heterogeneous data streams are then subjected to a transformation process to standardize and normalize the data, making it amenable to comprehensive analysis across different software platforms. This may include audio-to-text conversion through speech recognition for NLP analysis, video data being encoded into frame-by-frame images for micro-expression analysis, and timestamping every piece of data to maintain an accurate sequence of events. To enable a swift and efficient data flow conducive to real-time analysis, the system employs high-bandwidth data transmission protocols to relay the data to a central processing unit, which can be hosted on a secure cloud service using robust encryption standards or on-premise servers fortified by enterprise-grade security measures.

The central processing unit is the nexus of the system's analytical ability, equipped with high-throughput capabilities to handle the data-demands of the mechanism. Edge computing techniques may be employed at this juncture to perform initial preprocessing and data standardization, crucial for paring down the data to its most relevant and actionable form. Real-time frame analysis algorithms process the video data for facial recognition, identifying each participant and evaluating their expressions. Concurrently, pitch analysis modules scrutinize the audio streams to pinpoint voice frequency anomalies indicative of stress levels. For the textual component, specialized text stream processors apply advanced NLP algorithms to transcribed audio data to detect lexical anomalies indicative of deceptive behavior. It is understood that data received via these disparate communication modalities may be subjected to preprocessing and data standardization steps prior to being fed to one or more machine learning engines.

Following the initial preprocessing and data standardization facilitated by edge computing, the next phase entails a refinement process. Data collected from various sources undergoes an initial filtration to discard irrelevant information, streamlining the dataset for analysis. This process is augmented by edge computing's capability to preprocess data close to its source, reducing latency and offloading the central processing unit. Video, audio, and textual data may be standardized. For instance, video frames are resized, audio streams are normalized for bitrate and volume, and text data is cleansed of irregularities. Subsequently, various algorithms may be employed to extract essential features: facial recognition from video, pitch anomalies from audio, and deceptive lexical patterns from text, transforming them into a uniform format suitable for in-depth analysis. The final step integrates and further cleanses this data, ensuring alignment across modalities and preparing it for the machine learning engines. As appreciated by one of ordinary skill in the art, this layered approach to preprocessing and standardization not only streamlines the data but also enhances the system's analytical precision, making it adept at identifying and acting upon the most salient insights extracted from the inputs.

In the mechanism designed for monitoring virtual meetings, several sophisticated Natural Language Processing (NLP) algorithms are employed to analyze the conversational content for potential misappropriation. Sentiment analysis algorithms, for instance, play a crucial role in evaluating the emotional tone behind words, identifying stress or hesitation when sensitive topics are discussed. This can be achieved using libraries like NLTK or TextBlob. Additionally, Named Entity Recognition (NER) Algorithms, implemented via tools such as SpaCy, identify and classify key elements in the text into predefined categories, which is invaluable for flagging discussions around specific intellectual property (IP) or proprietary technologies. Topic Modeling Algorithms, like Latent Dirichlet Allocation (LDA), further aid in discovering the abstract topics within meeting transcripts, summarizing main topics, and highlighting any unusual or sensitive discussions.

Moreover, advanced language modeling algorithms, including BERT, or the like, may be utilized to understand context and predict word sequences, offering deep insights into the nuances of discussions and identifying anomalies in conversational patterns. Text classification algorithms, utilizing models such as support vector machines (SVM) and random forests, categorize sections of transcripts into predefined categories such as normal, suspicious, or warranting further investigation. Lastly, sequential models like recurrent neural networks (RNN) with long short-term memory (LSTM) cells are adept at detecting anomalies in speech patterns, including unusual pauses or rate changes that might suggest stress or deception. These NLP algorithms collectively enable the system to provide nuanced analysis and insights into the dynamics of virtual meetings, especially during discussions of sensitive IP, ensuring a comprehensive approach to safeguarding corporate intellectual data.

Each modality's data, after being transformed and standardized, is timestamped and synchronized using precision clock synchronization protocols to ensure the relational context between modalities is preserved. This process creates a cohesive and temporally mapped data landscape, a composite record that chronologically aligns facial expressions, vocal stresses, and conversational content. This orchestration of data from acquisition to analysis forms the foundation of a robust system capable of safeguarding the entity's intellectual property with precision and foresight.

Upon consolidating these synchronized data streams, in some embodiments, the system initiates its analysis algorithms, designed to run in parallel, to conduct a comprehensive review of the participants' behaviors in real-time. The audiovisual data undergoes a multi-tiered analysis; the video is parsed for facial micro-expressions using advanced machine learning models, while the audio is scrutinized for stress markers through spectral analysis. Simultaneously, the content of the conversation, derived from the audio-to-text conversion subsystem, is evaluated for anomalies in speech patterns such as hesitation or non-characteristic pause intervals.

In embodiments where these analyses raise concerns, indicative of a higher probability of an incident concerning IP security, the system compiles an assessment report. This report is routed through a secure, encrypted channel, and if the assessment crosses a predetermined threshold of concern, an immediate alert is dispatched to the entity's security team for intervention. The alert comprises a detailed construct of the detected anomalies, including time-stamped excerpts for rapid location and review of the concerning segments within the meeting's recording, and prompts a sequence of predefined security protocols.

Specifically, in some embodiments, the system may employ computer vision algorithms to detect micro-expressions that are incongruent with baseline emotional states commonly associated with standard discourse on trade secrets or proprietary methodologies. Concurrently, voice stress analysis, facilitated by machine learning models trained on a dataset of vocal patterns under various emotional states, scans for stress signatures in speech. These models may include convolutional neural networks (CNNs) for temporal feature extraction from audio data, and recurrent neural networks (RNNs) with long short-term memory (LSTM) cells to track the progression of speech patterns over time. Additionally, natural language processing (NLP) techniques are applied to assess conversation content, identifying deviations such as unusual pauses or phrasing that could indicate a higher probability of incident concerning IP confidentiality.

Upon detecting a composite of indicators that cumulatively surpass a threshold indicative of concern, the system initiates an alert protocol. This protocol may be configured to dispatch an encrypted communication directly to the entity's security team via a secure channel, such as an internally managed, end-to-end encrypted messaging system. The communication would include a detailed report encapsulating the specific indicators observed, the calculated probability of incident, and a direct link to the segment of the virtual meeting's recording for immediate review.

Following the alert, predefined procedures may be enacted, which may involve an immediate, albeit discreet, secondary monitoring of the ongoing conversation by a designated member of the security team. This response may be augmented by a subsequent in-depth analysis of the meeting transcript, cross-referenced against the behavioral analytics report. If the secondary review substantiates the system's alert, a follow-up action plan, or the like, is executed. This plan may comprise discreet investigative interviews with the participants, a forensic examination of the network activity during the time of the meeting, and a strategic review of access logs to sensitive IP repositories.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for integrative analysis of multimodal communication features for misappropriation detection, the system comprising:
a processing device;
a non-transitory storage device containing instructions when executed by the processing device, causes the processing device to perform the steps of:
receive data from multiple communication modalities;
preprocess the received data to standardized format and extract a communication pattern feature;
analyze the preprocessed data via a machine learning model to identify a behavioral deviation;
correlate findings a based on the data from the multiple communication modalities to determine anomaly detection feedback comprising communication authenticity and intent;
tune the machine learning model based on the anomaly detection feedback; and
deploy the machine learning model across the multiple communication modalities, wherein the machine learning model determines real-time misappropriation detection.

2. The system of claim 1, wherein the multiple communication modalities comprise at least spoken communication data, written text communication data, and non-verbal communication cues.

3. The system of claim 1, wherein preprocessing the received data further comprises normalizing disparate data formats to a uniform standard and extracting features indicative of specific communication patterns.

4. The system of claim 1, wherein analyzing the preprocessed data comprises employing the machine learning model to determine communication patterns suggesting attempts at misappropriation by comparing current data with historical behavior patterns associated with a user.

5. The system of claim 1, wherein correlating findings across communication modalities includes temporal alignment of communication events and analysis of physical characteristic data to determine identity verification of a user.

6. The system of claim 1, wherein tuning the machine learning model is based on feedback from anomaly detection outcomes comprising adjusting algorithm parameters and integrating new data sets into the machine learning model training process.

7. The system of claim 1, wherein the system is further configured to: generate an alert for communications identified as potential misappropriations, wherein the alerts comprise providing details of the detected anomalies and suggestions for subsequent actions.

8. A computer program product for integrative analysis of multimodal communication features for misappropriation detection, the computer program product comprising a non-transitory computer-readable medium comprising code causing an apparatus to:
receive data from multiple communication modalities;
preprocess the received data to standardized format and extract a communication pattern feature;
analyze the preprocessed data via a machine learning model to identify a behavioral deviation;
correlate findings based on the data from the multiple communication modalities to determine anomaly detection feedback comprising communication authenticity and intent;
tune the machine learning model based on the anomaly detection feedback; and
deploy the machine learning model across the multiple communication modalities, wherein the machine learning model determines real-time misappropriation detection.

9. The computer program product of claim 8, wherein the multiple communication modalities comprise at least spoken communication data, written text communication data, and non-verbal communication cues.

10. The computer program product of claim 8, wherein preprocessing the received data further comprises normalizing disparate data formats to a uniform standard and extracting features indicative of specific communication patterns.

11. The computer program product of claim 8, wherein analyzing the preprocessed data comprises employing the machine learning model to determine communication patterns suggesting attempts at misappropriation by comparing current data with historical behavior patterns associated with a user.

12. The computer program product of claim 8, wherein correlating findings across communication modalities includes temporal alignment of communication events and analysis of physical characteristic data to determine identity verification of a user.

13. The computer program product of claim 8, wherein tuning the machine learning model is based on feedback from anomaly detection outcomes comprising adjusting algorithm parameters and integrating new data sets into the machine learning model training process.

14. The computer program product of claim 8, further comprising the non-transitory computer-readable medium comprising code causing an apparatus to: generate an alert for communications identified as potential misappropriations, wherein the alerts comprise providing details of the detected anomalies and suggestions for subsequent actions.

15. A method for integrative analysis of multimodal communication features for misappropriation detection, the method comprising:
receive data from multiple communication modalities;
preprocess the received data to standardized format and extract a communication pattern feature;
analyze the preprocessed data via a machine learning model to identify a behavioral deviation;
correlate findings based on the data from the multiple communication modalities to determine anomaly detection feedback comprising communication authenticity and intent;
tune the machine learning model based on the anomaly detection feedback; and
deploy the machine learning model across the multiple communication modalities, wherein the machine learning model determines real-time misappropriation detection.

16. The method of claim 15, wherein the multiple communication modalities comprise at least spoken communication data, written text communication data, and non-verbal communication cues.

17. The method of claim 15, wherein preprocessing the received data further comprises normalizing disparate data formats to a uniform standard and extracting features indicative of specific communication patterns.

18. The method of claim 15, wherein analyzing the preprocessed data comprises employing the machine learning model to determine communication patterns suggesting attempts at misappropriation by comparing current data with historical behavior patterns associated with a user.

19. The method of claim 15, wherein correlating findings across communication modalities includes temporal alignment of communication events and analysis of physical characteristic data to determine identity verification of a user.

20. The method of claim 15, wherein tuning the machine learning model is based on feedback from anomaly detection outcomes comprising adjusting algorithm parameters and integrating new data sets into the machine learning model training process.
